(19) United States
(12) Patent Application Publication
(10) Pub. No.: US 2007/0117908 A1
(43) Pub. Date: May 24, 2007

(54) Blend for improving the brittleness and cold flowability of a carbon dioxide-propylene oxide copolymer and method for producing the same

(75) Inventors: Qinghai Zhou, Changchun (CN); Xiaojiang Zhao, Changchun (CN); Xianhong Wang, Changchun (CN); Fosong Wang, Changchun (CN); Tao Xiong, Changchun (CN); Fengxiang Gao, Changchun (CN)

Correspondence Address: DICKSTEIN SHAPIRO LLP, 1177 AVENUE OF THE AMERICAS (6TH AVENUE), NEW YORK, NY, 10036-2714, US

(73) Assignee: CHANGCHUN INSTITUTE OF APPLIED CHEMISTRY CHINESE ACADEMY OF SCIENCE

(21) Appl. No.: 11/589,940

(22) Filed: Oct. 31, 2006

(30) Foreign Application Priority Data
Nov. 21, 2005 (CN) 2005/10017300.1

(51) Int. Cl. C08K 5/09; B60C 1/00

(52) U.S. Cl. 524/492; 524/300

(57) ABSTRACT

The present invention relates to improvement of the brittleness and cold flowability of a carbon dioxide-propylene oxide copolymer (PPC). The invention provides a blend comprising 50 to 98 parts by weight of a PPC; 2 to 50 parts by weight of a poly(butylenes succinate) (PBS) or poly(butylene succinate/adipate) (PBSA); 1 part by weight of a maleic anhydride, and 0.5 to 3.0 parts by weight of SiO₂ and a method for producing the same. Compared with the pure PPC, the elongation rate at break of the blend of the invention increases by 3 to 15 times while the tensile strength maintains at 30 MPa or more. The blend of the PPC and PBSA can keep its dimension stably at 70° C., while the blend of the PPC and PBSA can keep its dimension stably at 55° C. No viscous flow occurs at these temperatures.

### TECHNICAL FIELD

The present invention relates to improvement of the brittleness and cold flowability of a carbon dioxide-propylene oxide copolymer. More specifically, the invention relates to a blend of a carbon dioxide-propylene oxide copolymer and other polymers capable of being biodegraded completely, and a method for producing the blend.

### BACKGROUND OF THE INVENTION

A carbon dioxide-propylene oxide copolymer (PPC) is a completely biodegradable aliphatic polycarbonate synthesized by copolymerizing carbon dioxide and propylene oxide. Chinese Patent No. CN1116332C and Chinese Patent Application No. 03105023.9 disclose synthesis methods of PPCs having high molecular weights. A PPC is amorphous, which has a molecular chain with relatively large flexibility, and the interaction force between the molecular chains is relatively weak. Glass transition temperatures of PPCs are relatively low (37-40° C.), furthermore, their terminal groups are hydroxyl groups, thus, the PPCs have shortages such as viscous flow at room temperature, a relatively large brittleness at low temperature, and the like.

An end-capped PPC can prevent the occurrence of unzipping reaction from its terminal so that its heat stability is improved. The thermal and mechanical property of a PPC can also be improved by blending the PPC with a different polymer material.

CHEN Liban points out that PPC is compatible with polymethyl acrylate, polyethyl acrylate, nitrocellulose, cellulose acetate, propyl cellulose, polycaprolactone, polyvinylidene fluoride, ethylene-vinyl acetate copolymer and the like (Polymer Bulletin, 3, 128-133, 1999).

Robenson points out that the blend obtained by blending a PPC with polyvinyl acetate (PVAc) (80:20) has a strength several times higher than that of the original polymer (U.S. Pat. No. 4,912,149 (1990)).

Dixon points out that the blending of PPC with polyvinyl chloride (PVC) can improve the melt flowability and oxygen blocking property of polyvinyl chloride (U.S. Pat. No. 4,137,280 (1979)).

Y E Xiaoguang et al. point out that when a PPC is blended with polycarbonate (PC) to form a matrix of thermoelectric conversion material, the elongation rate at break increases from 7% to 20%, while the break strength thereof decreases insignificantly. The blend obtained has a good workability, and can be produced into a molding material. Furthermore, a blend system of PPC and polyvinyl alcohol (PVA) has a good compatibility, and its toughness can be increased, which can be used to produce a film, a latex, a binder and the like (Chemistry Online, 10, 29-34 (1997)).

Poly(butylene succinate) (PBS) and poly(butylene succinate/adipate) (PBSA) are semi-crystalline polymers, and can be biodegraded completely. The glass transition temperatures thereof can be adjusted in the range of −32 to 45° C. However, the production costs are relatively high.

None of the above-mentioned references address the technical problems of the brittleness and cold flowability of the PPC.

### DISCLOSURE OF THE INVENTION

As a result of intense studies for solving the technical problems of the brittleness and cold flowability of the PPC, the inventors found that by blending carbon dioxide-propylene oxide copolymer with PBS or PBSA, the thermal and mechanical property, brittleness, and cold flowability of PPC can be improved while the respective complete biodegradability can be maintained.

One object of the invention is to improve the brittleness and cold flowability of the PPC.

The object can be achieved by the following aspects.

In one aspect, the present invention provides a blend of a PPC, comprising: 50 to 98 parts by weight of PPC; 2 to 50 parts by weight of PBS or PBSA; 1 part by weight of maleic anhydride, and 0.5 to 3.0 parts by weight of SiO₂.

In another aspect of the invention, the blend of the PPC comprises: 60 to 95 parts by weight of PPC; 5 to 40 parts by weight of PBS or PBSA; 1 part by weight of maleic anhydride, and 1 to 2 parts by weight of SiO₂.

In still another aspect of the invention, the PPC has a number average molecular weight of 45,000 to 120,000 g/mol; a molecular weight distribution index of 2.5 to 6.5; and a glass transition temperature of 35-39° C.

In another aspect of the invention, the PPC has a number average molecular weight of 55,000 to 90,000; a molecular weight distribution index of 3.0 to 5.0; a glass transition temperature of 35-39° C.

In still another aspect of the invention, the PBS has a density of 1.26 g/cm³, a deforming temperature of 97° C., a crystalline degree of 35-45%, a glass transition temperature of −32° C., and a melting point of 114-115° C.

In another aspect of the invention, the PBSA has a density of 1.23 g/cm³, a deforming temperature of 69° C., a crystalline degree of 20-35%, a glass transition temperature of −45° C., and a melting point of 93-95° C.

In one aspect of the invention, a method for preparing a blend of a PPC is provided, the method comprises the steps of:

mixing 50 to 98 parts by weight of PPC; 2 to 50 parts by weight of PBS or PBSA; 1 part by weight of maleic anhydride, and 0.5 to 3.0 parts by weight of SiO₂ in a high-speed blender uniformly;

vacuum-drying the mixture; and

banburying the vacuum-dried mixture in a mixer.

In one aspect of the invention, the vacuum-drying is carried out at a temperature of 20 to 60° C. for 1 to 20 hours.

In another aspect of the invention, the mixer is a haake mixer which is operated with a speed of 10 to 50 rpm/min at a temperature of 100 to 160° C.

### MODE OF CARRYING OUT THE INVENTION

The invention mainly uses a biodegradable aliphatic polycarbonate having a long alkyl chain in its main chain to improve the brittleness and viscous flowability of a PPC.

The PPC used in the invention is produced according to the methods provided in Chinese Patent No. CN 1116332C and Chinese Patent Application No. 03105023.9 (a bulk polymerization method using a rare earth ternary catalyst, temperature: 65 to 70° C., the pressure of carbon dioxide: 3.0-3.5 MPa). The PPC has a number average molecular weight Mₙ of 45,000 to 120,000 g/mol, and preferably 55,000 to 90,000 g/mol; a molecular weight distribution index M_{w}/Mₙ of 2.5 to 6.5, and preferably 3.0 to 5.0; and a glass transition temperature of 35-39° C.

PBS and PBSA (Bionolle) are provided by Showa Highpolymer Co., Ltd.

PBS has a density of 1.26 g/cm³, a deforming temperature of 97° C., a crystalline degree of 35-45%, a glass transition temperature of −32° C., and a melting point of 114-115° C.

PBSA has a density of 1.23 g/cm³, a deforming temperature of 69° C., a crystalline degree of 20-35%, a glass transition temperature of −45° C., and a melting point of 93-95° C.

In order to prevent the “unzipping” reaction of PPC during blending, PPC is often end-capped with an end-capping reagent. The end-capping reagent for the PPC of the invention is a commercially available maleic anhydride (MAH) (Grade 1). As an end-capping reagent, maleic anhydride not only facilitates the blending process, but also the raw materials thereof are readily available and cost-effective.

SiO₂ has antisticking and acid-eliminating effects during a plastic processing.

The method for improving the brittleness and cold flowability of a PPC according to the invention is as follows:

weighing proportionally 50 to 98 parts by weight, preferably 60 to 95 parts by weight of the PPC; 2 to 50 parts by weight, preferably 5 to 40 parts by weight of PBS or PBSA; 1 part by weight of maleic anhydride (MAH); and 0.5 to 3.0 parts by weight, preferably 1 to 2 parts by weight of SiO₂;

mixing the substances uniformly in a high-speed blender to obtain a mixture;

vacuum-drying the mixture at 40° C. for 10 hours; and

banburying the vacuum-dried mixture in a Banbury mixer with a speed of 30 rpm/min at a temperature of 140° C., to obtain a blend of the PPC and PBS or a blend of the PPC and PBSA.

The above blend is pressed at a temperature of 140° C. to form a sheet having a thickness of 1 mm, and the mechanical property of the sheet is tested. The result of the test shows that the brittleness and viscous flowability of the PPC at room temperature are improved by the method according to the invention. Compared with pure PPC, the elongation rate at break of the resultant blend of the PPC is increased by 3 to 15 times, while the tensile strength thereof is maintained at 30 MPa or more. The blend of the PPC and PBS can maintain its dimension stable at 70° C., while the blend of the PPC and PBSA can maintain its dimension stable at 55° C. In both cases, no viscous flow occurred. Thus, the thermal resistance of the PPC is improved significantly.

### EXAMPLE 1

92.5 parts by weight of a PPC having a number average molecular weight of 60,000 g/mol and a molecular weight distribution index of 4.3, 5 parts by weight of PBS, 1 part by weight of MAH, and 1.5 parts by weight of SiO₂ were mixed uniformly in a high-speed blender. After vacuum-dried in a vacuum oven at 40° C. for 10 hours, the mixture was banburied in a haake mixer with a speed of 30 rpm/min at a temperature of 140° C. until the torque curve became stable, thus a blend of the PPC and PBS was obtained.

The blend of the PPC and PBS obtained above was pressed into a sheet having a thickness of 1 mm with a vulcanizing press at 140° C. The sheet had a Young's modulus of 639.5 MPa; a yield strength of 32.48 MPa; a tensile strength of 32.48 MPa; an elongation rate at break of 190.9%; a work-to-break of 0.58 J/mm². No viscous flow occurred at 70° C.

### EXAMPLE 2

87.5 parts by weight of a PPC having a number average molecular weight of 56,000 g/mol and a molecular weight distribution index of 3.5, 10 parts by weight of PBS, 1 part by weight of MAH, and 1.5 parts by weight of SiO₂ were mixed uniformly in a high-speed blender. After vacuum-dried in a vacuum oven at 40° C. for 10 hours, the mixture was banburied in a haake mixer with a speed of 30 rpm/min at a temperature of 140° C. until the torque curve became stable, thus a blend of the PPC and PBS was obtained.

The blend of the PPC and PBS obtained above was pressed into a sheet having a thickness of 1 mm with a vulcanizing press at 140° C. The sheet had a Young's modulus of 566.3 MPa; a yield strength of 27.33 MPa; a tensile strength of 27.33 MPa; an elongation rate at break of 463.7%; a work-to-break of 1.26 J/mm². Its dimensional stability could be maintained and no viscous flow occurred at 70° C.

### EXAMPLE 3

58.5 parts by weight of a PPC having a number average molecular weight of 71,000 g/mol and a molecular weight distribution index of 3.5, 39 parts by weight of PBS, 1 part by weight of MAH, and 1.5 parts by weight of SiO₂ were mixed uniformly in a high-speed blender. After vacuum-dried in a vacuum oven at 40° C. for 10 hours, the mixture was banburied in a haake mixer with a speed of 30 rpm/min at a temperature of 140° C. until the torque curve became stable, thus a blend of the PPC and PBS was obtained.

The blend of the PPC and PBS obtained above was pressed into a sheet having a thickness of 1 mm with a vulcanizing press at 140° C. The sheet had a Young's modulus of 598.2 MPa; a yield strength of 34.71 MPa; a tensile strength of 34.71 MPa; an elongation rate at break of 444.8%; a work-to-break of 1.90 J/mm². Its dimensional stability could be maintained and no viscous flow occurred at 70° C.

### EXAMPLE 4

77.5 parts by weight of a PPC having a number average molecular weight of 85,000 g/mol and a molecular weight distribution index of 5.0, 20 parts by weight of PBS, 1 part by weight of MAH, and 2 parts by weight of SiO₂ were mixed uniformly in a high-speed blender. After vacuum-dried in a vacuum oven at 40° C. for 10 hours, the mixture was banburied in a haake mixer with a speed of 30 rpm/min at a temperature of 140° C. until the torque curve became stable, thus a blend of the PPC and PBS was obtained.

The blend of the PPC and PBS obtained above was pressed into a sheet having a thickness of 1 mm with a vulcanizing press at 140° C. The sheet had a Young's modulus of 772.6 MPa; a yield strength of 39.43 MPa; a tensile strength of 39.43 MPa; an elongation rate at break of 126.5%; a work-to-break of 0.54 J/mm². Its dimensional stability could be maintained and no viscous flow occurred at 70° C.

### EXAMPLE 5

87.5 parts by weight of a PPC having a number average molecular weight of 56,000 g/mol and a molecular weight distribution index of 3.5, 10 parts by weight of PBSA, 1 part by weight of MAH, and 1.5 parts by weight of SiO₂ were mixed uniformly in a high-speed blender. After vacuum-dried in a vacuum oven at 40° C. for 10 hours, the mixture was banburied in a haake mixer with a speed of 30 rpm/min at a temperature of 140° C. until the torque curve became stable, thus a blend of the PPC and PBSA was obtained.

The blend of the PPC and PBSA obtained above was pressed into a sheet having a thickness of 1 mm with a vulcanizing press at 140° C. The sheet had a Young's modulus of 612.5 MPa; a yield strength of 30.42 MPa; a tensile strength of 35.24 MPa; an elongation rate at break of 440.8%; a work-to-break of 1.71 J/mm². Its dimensional stability could be maintained and no viscous flow occurred at 70° C.

### COMPARATIVE EXAMPLE

97.5 parts by weight of a PPC having a number average molecular weight of 56,000 g/mol and a molecular weight distribution index of 3.5, 1 part by weight of MAH, and 1.5 parts by weight of SiO₂ were mixed uniformly in a high-speed blender. After vacuum-dried in a vacuum oven at 40° C. for 10 hours, the mixture was banburied in a haake mixer with a speed of 30 rpm/min at a temperature of 140° C. until the torque curve became stable, thus a sample of the PPC was obtained.

The sample of the PPC obtained above was pressed into a sheet having a thickness of 1 mm with a vulcanizing press at 140° C. The sheet had a Young's modulus of 717.6 MPa; a yield strength of 42.6 MPa; a tensile strength of 42.6 MPa; an elongation rate at break of 34.73%; a work-to-break of 0.17 J/mm². Viscous flow was observed at room temperature (25 to 30° C.). The viscous flow was severe at 35° C. and above, resulting in agglomerated pellets.

We claim:

1. A blend of a carbon dioxide-propylene oxide copolymer, comprising: 50 to 98 parts by weight of a carbon dioxide-propylene oxide copolymer; 2 to 50 parts by weight of a poly(butylenes succinate) (PBS) or poly(butylene succinate/adipate) (PBSA); 1 part by weight of a maleic anhydride, and 0.5 to 3.0 parts by weight of SiO₂.

2. The blend according to claim 1, wherein the carbon dioxide-propylene oxide copolymer is 60 to 95 parts by weight, the PBS or PBSA is 5 to 40 parts by weight, the maleic anhydride is 1 part by weight, and SiO₂ is 1 to 2 parts by weight.

3. The blend according to claim 1, wherein the carbon dioxide-propylene oxide copolymer has a number average molecular weight of 45,000 to 120,000 g/mol; a molecular weight distribution index of 2.5 to 6.5; and a glass transition temperature of 35-39° C.

4. The blend according to claim 1, wherein the carbon dioxide-propylene oxide copolymer has a number average molecular weight of 55,000 to 90,000; a molecular weight distribution index of 3.0 to 5.0; and a glass transition temperature of 35-39° C.

5. The blend according to claim 1, wherein the PBS has a density of 1.26 g/cm³, a deforming temperature of 97° C., a crystalline degree of 35-45%, a glass transition temperature of −32° C., and a melting point of 114-115° C.

6. The blend according to claim 1, wherein the PBSA has a density of 1.23 g/cm³, a deforming temperature of 69° C., a crystalline degree of 20-35%, a glass transition temperature of −45° C., and a melting point of 93-95° C.

7. A method for preparing a blend of a carbon dioxide-propylene oxide copolymer, comprising the steps of:
mixing 50 to 98 parts by weight of a carbon dioxide-propylene oxide copolymer; 2 to 50 parts by weight of a PBS or PBSA; 1 part by weight of a maleic anhydride, and 0.5 to 3.0 parts by weight of SiO₂ in a high-speed blender uniformly;
vacuum-drying the mixture; and
banburying the vacuum-dried mixture in a mixer.

8. The method according to claim 7, wherein the vacuum-drying is carried out at a temperature of 20 to 60° C. for 1 to 20 hours.

9. The method according to claim 7, wherein the mixer is a haake mixer which is operated at a speed of 10 to 50 rpm/min, and at a temperature of 100 to 160° C.
